(19) United States
(12) Patent Application Publication
(10) Pub. No.: US 2026/0237045 A1
(43) Pub. Date: Aug. 13, 2026

(54) ANOMALY DETECTION APPARATUS AND ANOMALY DETECTION METHOD

(71) Applicant: Mitsubishi Electric Corporation, Tokyo (JP)

(72) Inventor: Tetsu KITANI, Tokyo (JP)

(73) Assignee: Mitsubishi Electric Corporation, Tokyo (JP)

(21) Appl. No.: 19/564,660

(22) Filed: Mar. 12, 2026

Related U.S. Application Data
(63) Continuation of application No. PCT/JP2023/040873, filed on Nov. 14, 2023.

(51) Int. Cl. G06T 7/00; G06T 7/11

(52) U.S. Cl. CPC G06T 7/0002; G06T 7/11; G06T 2207/20076

(57) ABSTRACT

An object detection unit (120) detects a region in which a defect of an inspection target is inferred to appear, as a current defect region, by executing object detection on a current target image acquired by imaging the inspection target, and obtains accuracy of inference for the current defect region, as a current region confidence level. An inspection value calculation unit (140) calculates a current inspection value using an inspection coefficient used for calculating an inspection value and the current region confidence level. An anomaly detection unit (150) determines whether or not an anomaly has occurred in the inspection target based on the current inspection value.

### CROSS REFERENCE TO RELATED APPLICATION

This application is a Continuation of PCT International Application No. PCT/JP2023/040873, filed on Nov. 14, 2023, which is hereby expressly incorporated by reference into the present application.

### TECHNICAL FIELD

The present disclosure relates to a technology for detecting an anomaly in an object using an image.

### BACKGROUND ART

In safety inspection patrols such as maintenance of infrastructure, high Recall (over-detection tendency) is common to reduce oversight.

However, in return for this, detection of an unnecessary object such as a fallen leaf, a fallen object, or the like (false detection) occurs.

There is a method that accumulates inference confidence levels (scores) to reduce false detection, and performs determination.

However, there is a risk of delayed detection with this method.

On the other hand, a method for solving delay in detection has been proposed.

Patent Literature 1 proposes the following method. In the method of Patent Literature 1, when there is an abrupt change in a feature between images that come before and after each other in a time series, a score is added, and when the score is equal to or greater than a threshold value, a jump out of an object is considered to have been detected.

However, in this method, since the presence of an object that was not present at the previous inspection is considered the abrupt change, the presence of a fallen leaf or the like causes the score to be added, the score exceeds the threshold value, and false detection occurs.

### CITATION LIST

### Patent Literature

Patent Literature 1: JP 2016-12226 A

### SUMMARY OF INVENTION

### Technical Problem

The present disclosure aims to enable reduction of false detection of a defect in an inspection target, and to enable detection of an anomaly in the inspection target.

### Solution to Problem

An anomaly detection apparatus according to the present disclosure includes:
an object detection unit to detect a region in which a defect of an inspection target is inferred to appear, as a current defect region, by executing object detection on a current target image acquired by imagining the inspection target, and to obtain accuracy of inference for the current defect region, as a current region confidence level;
an inspection value calculation unit to calculate a current inspection value using an inspection coefficient used for calculating an inspection value and the current region confidence level; and
an anomaly detection unit to determine whether or not an anomaly has occurred in the inspection target based on the current inspection value.

### Advantageous Effects of Invention

According to the present disclosure, it is possible to reduce false detection of a defect in an inspection target, and to detect an anomaly in the inspection target.

### BRIEF DESCRIPTION OF DRAWINGS

FIG. 1 is a configuration diagram of an anomaly detection apparatus 100 in Embodiment 1.

FIG. 2 is a diagram illustrating an example of a configuration of an anomaly detection system 200 in Embodiment 1.

FIG. 3 is a flowchart of an anomaly detection method in Embodiment 1.

FIG. 4 is a diagram for explaining key features of Embodiment 1.

FIG. 5 is a flowchart of the anomaly detection method in Embodiment 2.

FIG. 6 is a diagram for explaining key features of Embodiment 2.

FIG. 7 is a flowchart of the anomaly detection method in Embodiment 3.

FIG. 8 is a diagram for explaining key features of Embodiment 3.

FIG. 9 is a hardware configuration diagram of the anomaly detection apparatus 100 in the embodiments.

### DESCRIPTION OF EMBODIMENTS

In the embodiments and drawings, the same elements or corresponding elements are denoted by the same reference sign. Description of an element denoted by the same reference sign as that of an element that has been described will be suitably omitted or simplified. Arrows in diagrams mainly indicate flows of data or flows of processing.

### Embodiment 1

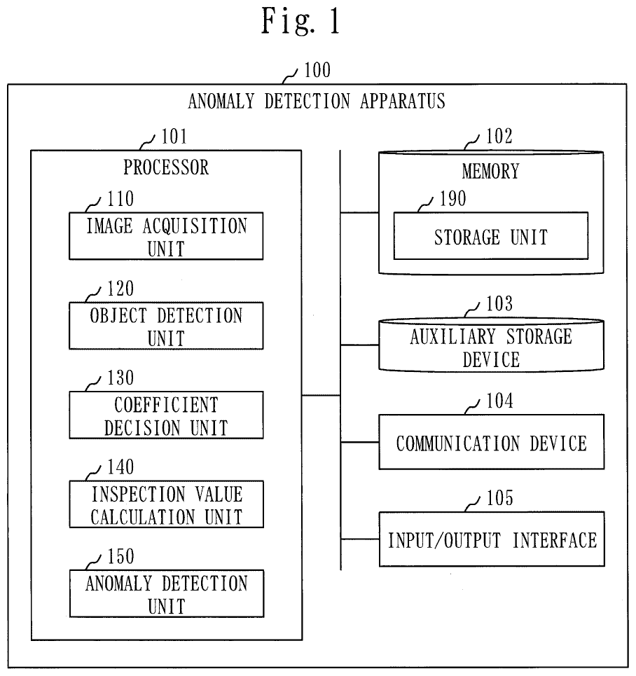

An anomaly detection apparatus 100 will be described based on FIGS. 1 to 4.

### Description of Configuration

A configuration of the anomaly detection apparatus 100 will be described based on FIG. 1.

The anomaly detection apparatus 100 is a computer that includes pieces of hardware such as a processor 101, a memory 102, an auxiliary storage device 103, a communication device 104, and an input/output interface 105. These pieces of hardware are connected with one another through signal lines.

The processor 101 is an IC that performs arithmetic processing, and controls other pieces of hardware. The processor 101 is, for example, a CPU, a DSP, or a GPU.

IC is an abbreviation for Integrated Circuit.

CPU is an abbreviation for Central Processing Unit.

DSP is an abbreviation for Digital Signal Processor.

GPU is an abbreviation for Graphics Processing Unit.

The memory 102 is a volatile or non-volatile storage device. The memory 102 is also referred to as a main storage device or a main memory. The memory 102 is, for example, an RAM. Data stored in the memory 102 is saved in the auxiliary storage device 103 as necessary.

RAM is an abbreviation for Random Access Memory.

The auxiliary storage device 103 is a non-volatile storage device. The auxiliary storage device 103 is, for example, an ROM, an HDD, a flash memory, or a combination of these. Data stored in the auxiliary storage device 103 is loaded into the memory 102 as necessary.

ROM is an abbreviation for Read Only Memory.

HDD is an abbreviation for Hard Disk Drive.

The communication device 104 is a receiver and a transmitter. The communication device 104 is, for example, a communication chip or an NIC. Communication of the anomaly detection apparatus 100 is performed using the communication device 104.

NIC is an abbreviation for Network Interface Card.

The input/output interface 105 is a port to which input devices and output devices are connected. The input/output interface 105 is, for example, a USB terminal, the input devices are, for example, a keyboard and a mouse, and the output device is, for example, a display. Input and output of the anomaly detection apparatus 100 is performed using the input/output interface 105.

USB is an abbreviation for Universal Serial Bus.

The anomaly detection apparatus 100 includes elements such as an image acquisition unit 110, an object detection unit 120, a coefficient decision unit 130, an inspection value calculation unit 140, and an anomaly detection unit 150. These elements are implemented by software.

The auxiliary storage device 103 stores an anomaly detection program for causing a computer to function as the image acquisition unit 110, the object detection unit 120, the coefficient decision unit 130, the inspection value calculation unit 140, and the anomaly detection unit 150. The anomaly detection program is loaded into the memory 102 and executed by the processor 101.

The auxiliary storage device 103 also stores an OS. At least a part of the OS is loaded into the memory 102 and executed by the processor 101.

While executing the OS, the processor 101 executes the anomaly detection program.

OS is an abbreviation for Operating System.

Input/output data of the anomaly detection program is stored in a storage unit 190.

The memory 102 functions as the storage unit 190. However, storage devices such as the auxiliary storage device 103, a register in the processor 101, and a cache memory in the processor 101 may also function as the storage unit 190 instead of the memory 102 or together with the memory 102.

The anomaly detection program can be recorded (stored) in a non-volatile recording medium such as an optical disc or a flash memory, in a computer readable format.

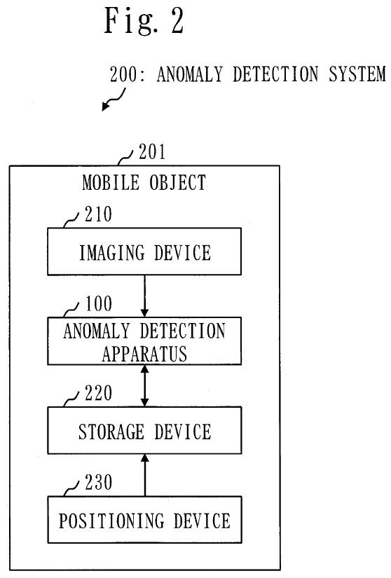

FIG. 2 illustrates an example of a configuration of an anomaly detection system 200.

The anomaly detection system 200 is a system that uses the anomaly detection apparatus 100.

The anomaly detection system 200 is implemented in a mobile object 201, for example.

An example of the mobile object 201 is an automobile.

The mobile object 201 includes the anomaly detection apparatus 100, an imaging device 210, a storage device 220, and a positioning device 230.

The anomaly detection apparatus 100 communicates with each of the imaging device 210 and the storage device 220.

The imaging device 210 is a device for imagining an inspection target. The imaging device 210 performs imagining at each date and time, and outputs an image.

The image acquired by imagining the inspection target is referred to as a target image.

The inspection target is an object being inspected using the target image. The inspection target is, for example, a road, a wall inside a tunnel, a bridge, or the like.

The storage device 220 is a storage device located outside of the anomaly detection apparatus 100. The storage device 220 stores, for example, driving history data or the like.

The driving history data is data that indicates a location (a driving location) of the mobile object 201 at each date and time.

The positioning device 230 is a device for positioning the mobile object 201. The positioning device 230 executes positioning at each date and time, and registers the driving location at each date and time in the driving history data stored in the storage device 220.

### Description of Operation

A procedure for operation of the anomaly detection apparatus 100 is equivalent to an anomaly detection method. Further, the procedure for the operation of the anomaly detection apparatus 100 is equivalent to a procedure for processing by the anomaly detection program.

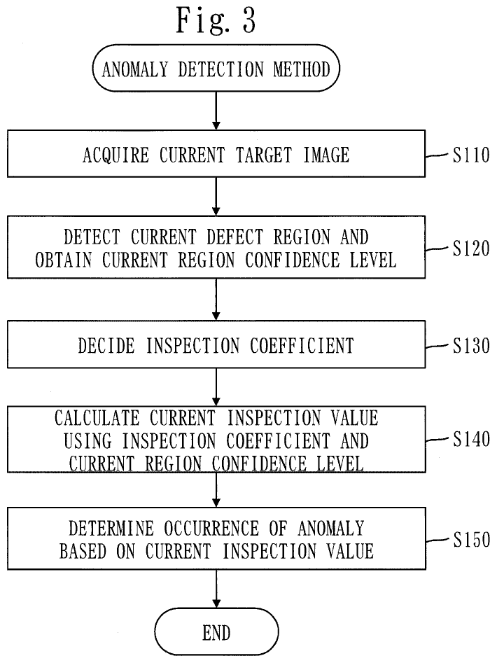

The anomaly detection method will be described based on FIG. 3.

Steps S110 to S150 are repeatedly executed.

In step S110, the image acquisition unit 110 acquires a current target image.

The current target image is an image to be used in a current inspection.

The current target image is acquired by any method. The image acquisition unit 110 receives a latest image outputted from the imaging device 210 as the current target image, for example.

The inspection target (the inspection target that has currently been imaged) that appears in the current target image is referred to as a current inspection target.

In step S120, the object detection unit 120 detects a current defect region by executing object detection on the current target image.

The defect region is a region in which a defect of the inspection target is inferred to appear in the target image. The current defect region is a region in which a defect that has occurred on a surface of the inspection target is inferred to appear at the time of imagining when the current target image has been acquired (at the time of the current imaging).

The defect is generated continuously in a time series. A location of the defect does not change regardless of the passage of time, and the defect grows larger as time passes. Further, the defect is generated over a long period of time (a year or several years, for example). Examples of defects are a crack and a hole.

The object detection is executed by any method. The object detection unit 120 executes the object detection using an object detection model with the current target image as input, for example. The object detection model is a learned model used for the object detection. An example of an object detection algorithm is YOLO. YOLO is an abbreviation for You Only Look Once.

Further, the object detection unit 120 obtains a region confidence level for the current defect region.

The region confidence level is a value that represents accuracy of inference for the defect region.

The region confidence level may be obtained as follows.

First, the object detection unit 120 acquires from the object detection model, an inference score for the defect region. The inference score calculated by the object detection model for an object region (a bounding box) detected by the object detection model is used as the inference score for the defect region. When a plurality of object regions are detected and a plurality of inference scores for the plurality of object regions are obtained, for example, a statistical value of the plurality of inference scores is used as the inference score for the defect region. An example of the statistical value is an average value, a maximum value, or a minimum value.

Further, the object detection unit 120 determines a visibility score for the target image. The visibility score is a value that represents visibility of an image. An edge that is easier to see has a higher visibility score. The higher the average luminance and contrast, the higher the visibility score, for example.

Then, the object detection unit 120 calculates the region confidence level using the inference score for the defect region and the visibility score for the target image. The region confidence level is calculated by any method.

The region confidence level may also be calculated using another score. Further, the inference score for the defect region, the visibility score for the target image, or the other score may also be used as the region confidence level.

The region confidence level for the current defect region is referred to as a current region confidence level.

The current region confidence level is saved and used as a previous region confidence level at the next inspection for the same inspection target as the current inspection target.

The current region confidence level is saved as follows, for example. The target image is attached with information that indicates an imaging date and time. The object detection unit 120 selects from dates and times indicated in the driving history data in the storage device 220, a date and time that is closest to the imaging date and time of the current target image, and registers the current region confidence level associated with the selected date and time, to the driving history data.

In step S130, the coefficient decision unit 130 decides an inspection coefficient.

The inspection coefficient is a coefficient used for calculation of an inspection value.

The inspection value is a value that is referred to in order to determine whether or not an anomaly has occurred in the inspection target.

Specifically, the coefficient decision unit 130 decides the inspection coefficient based on a length of an uninspected period. The inspection coefficient is decided by any method based on the length of the uninspected period.

The inspection coefficient is proportional to the length of the uninspected period. In other words, the longer the uninspected period, the larger the inspection coefficient.

The uninspected period is equivalent to a period from the previous imaging time to the current imaging time for the same inspection target.

The uninspected period is determined as follows, for example.

The target image is attached with information that indicates an imagining date and time.

First, the coefficient decision unit 130 refers to the driving history data in the storage device 220 to determine a current date and time that is equivalent to a current imagining time. The current date and time is a date and time that is closest to the imaging date and time of the current target image among the dates and times indicated in the driving history data. The driving location corresponding to the current date and time is referred to as a current location.

Next, the coefficient decision unit 130 refers to the driving history data in the storage device 220 to find a driving location (an equivalent location) that is equivalent to the current location. The equivalent location is a driving location whose distance from the current location is included in an allowable range.

Then, the coefficient decision unit 130 refers to the driving history data in the storage device 220 to determine a previous date and time that is equivalent to a previous imagining time. The previous date and time is a date and time that is closest to the current date and time among the dates and times with which each equivalent location is associated.

A period from the previous date and time to the current date and time is the uninspected period.

In step S140, the inspection value calculation unit 140 calculates a current inspection value using the inspection coefficient and the current region confidence level.

The current inspection value is calculated as follows, for example.

First, the inspection value calculation unit 140 calculates a change amount of region confidence level dS using the previous region confidence level and the current region confidence level.

The change amount of region confidence level dS is a difference between the previous region confidence level and the current region confidence level. Specifically, the inspection value calculation unit 140 calculates the change amount of region confidence level dS by subtracting the previous region confidence level from the current region confidence level.

The previous region confidence level is a region confidence level calculated as the current region confidence level at the previous inspection for the same inspection target as the current inspection target.

The previous region confidence level is acquired as follows, for example. The driving history data in the storage device 220 indicates the region confidence level together with the driving location, associated with each date and time. The previous date and time is as described in step S130. The inspection value calculation unit 140 acquires from the driving history data, the region confidence level associated with the previous date and time. The region confidence level to be acquired is the previous region confidence level.

Then, the inspection value calculation unit 140 adds to a previous inspection value P_{N-1}, a value (an inspection score) calculated by multiplying an inspection coefficient K by the change amount of region confidence level dS. As a result, a current inspection value P_{N} is calculated.

The current inspection value P_{N} is equivalent to a value (an accumulated value) obtained by accumulating inspection scores.

The current inspection value P_{N} is represented by the following formula.

$${P}_{N} = {P}_{N - 1} + K \cdot dS$$

The current inspection value P_{N} is saved and used as the previous inspection value P_{N-1} at the next inspection for the same inspection target as the current inspection target.

The current inspection value P_{N} is saved as follows, for example. The target image is attached with information that indicates an imaging date and time. The inspection value calculation unit 140 selects from dates and times indicated in the driving history data in the storage device 220, a date and time that is closest to the imaging date and time of the current target image, and registers the current inspection value P_{N} associated with the selected date and time, to the driving history data.

The previous inspection value P_{N-1} is an inspection value calculated as the current inspection value P_{N} at the previous inspection for the same inspection target as the current inspection target.

The previous inspection value P_{N-1} is acquired as follows, for example. The driving history data in the storage device 220 indicates the inspection value together with the driving location, associated with each date and time. The previous date and time is as described in step S130. The inspection value calculation unit 140 acquires from the driving history data, the inspection value associated with the previous date and time. The inspection value to be acquired is the previous inspection value P_{N-1}.

In step S150, the anomaly detection unit 150 determines whether or not an anomaly has occurred in the inspection target based on the current inspection value.

The occurrence of the anomaly is determined as follows.

The anomaly detection unit 150 compares the current inspection value with a threshold value. The threshold value is decided in advance.

When the current inspection value is greater than the threshold value, the anomaly detection unit 150 determines that the anomaly has occurred in the inspection target.

Then, the anomaly detection unit 150 outputs a determination result.

The determination result is information that indicates whether or not the anomaly has occurred in the inspection target.

The anomaly detection unit 150 registers the imaging date and time, the current date and time, the current location, the determination result, and the like of the current target image in the determination history data, for example. The determination history data is stored in, for example, the storage unit 190.

### Key Features of Embodiment 1

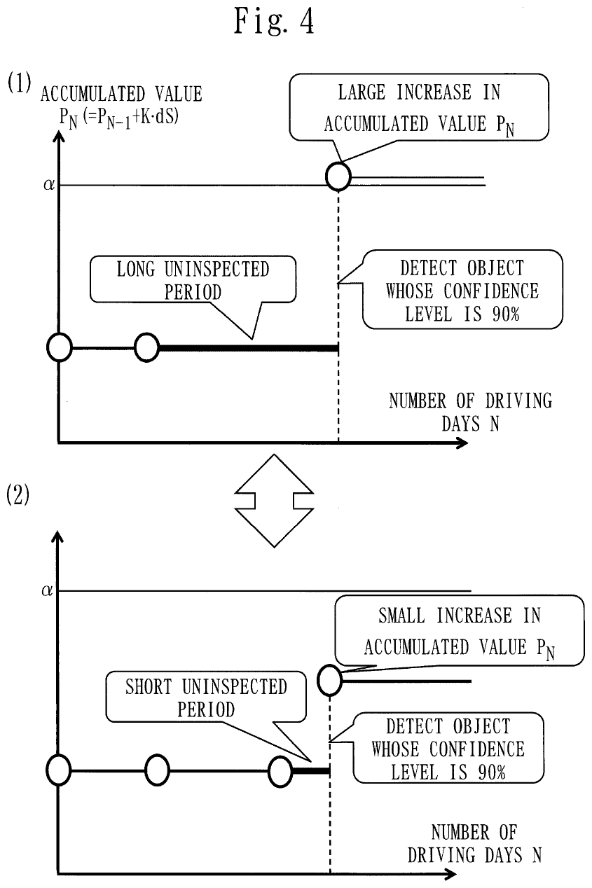

Key features of Embodiment 1 will be described based on FIG. 4.

The anomaly detection apparatus 100 accumulates scores (inference scores, visibility scores, or the like) obtained at inspection, and considers exceeding an accumulated value P (an inspection value) above a threshold value α to be detection of an anomaly.

When the uninspected period is long, a defect might be formed on a surface (a road surface, for example) of the inspection target during the uninspected period. However, it is unreasonable to sharply increase the accumulated value P by accumulating high scores despite a short uninspected period, and to determine that a defect has been formed on the surface of the inspection target.

Therefore, the anomaly detection apparatus 100 sets a coefficient K that is proportional to an elapsed time from the previous inspection. Then, the anomaly detection apparatus 100 adds to the accumulated value P, a multiplication result of the coefficient K and the change amount dS of inference confidence level (region confidence level).
(1) When the uninspected period is long, the coefficient K is large, and an increase in the accumulated value P is large.
(2) When the uninspected period is short, the coefficient K is small, and an increase in the accumulated value P is small.

### Effects of Embodiment 1

In conventional technology, when an object (a dead leaf or the like) that has not been seen before is detected, the score rises sharply. Therefore, false detection easily occurs due to a discontinuous condition such as the dead leaf.

In Embodiment 1, the coefficient is decided according to the length of the uninspected period. The longer the uninspected period, the larger the coefficient, and the shorter the uninspected period, the smaller the coefficient. Then, determination is performed using the score (the inspection value) based on this coefficient.

As a result, Embodiment 1 can reduce false detection of a defect, and detect an anomaly in the inspection target.

### Embodiment 2

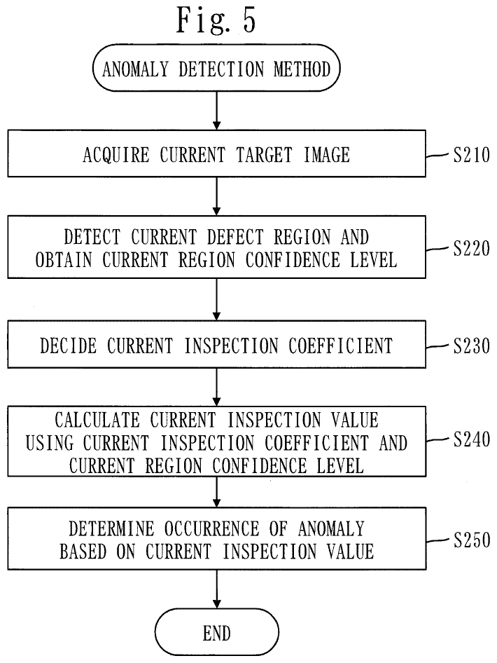

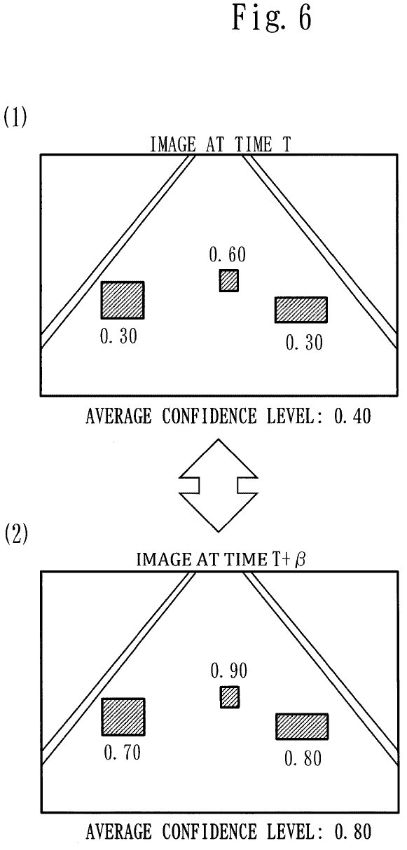

For an embodiment in which the inspection coefficient is changed according to a change in the region confidence level, points that differ from Embodiment 1 will be mainly described based on FIGS. 5 and 6.

### Description of Configuration

A configuration of the anomaly detection apparatus 100 is the same as that in Embodiment 1.

### Description of Operation

The anomaly detection method will be described based on FIG. 5.

Steps S210 to S250 are equivalent to steps S110 to S150 in Embodiment 1.

In step S210, the image acquisition unit 110 acquires the current target image.

Step S210 is the same as step S110 in Embodiment 1.

In step S220, the object detection unit 120 detects the current defect region by executing object detection on the current target image.

Further, the object detection unit 120 obtains the region confidence level for the current defect region.

Specifically, the object detection unit 120 detects one or more current defect regions, and obtains one or more current region confidence levels corresponding to the one or more current defect regions.

The method of object detection is the same as the method in Embodiment 1.

The method of determining the region confidence level is the same as the method in Embodiment 1.

In step S230, the coefficient decision unit 130 decides a current inspection coefficient.

The current inspection coefficient is saved in the same manner as the current region confidence level, and used as a previous inspection coefficient at the next inspection for the same inspection target as the current inspection target.

The inspection coefficient is decided as follows.

First, the coefficient decision unit 130 calculates an average of one or more current region confidence levels. The calculated average is referred to as a current average confidence level.

The current average confidence level is saved in the same manner as the current region confidence level, and used as a previous average confidence level at the next inspection for the same inspection target as the current inspection target.

Next, the coefficient decision unit 130 calculates a change amount of average confidence level using the previous average confidence level and the current average confidence level.

The previous average confidence level is an average confidence level calculated as the current average confidence level at the previous inspection for the same inspection target as the current inspection target.

The previous average confidence level is acquired as follows, for example. The driving history data in the storage device 220 indicates the average confidence level together with the driving location, associated with each date and time. The previous date and time is as described in step S130 of Embodiment 1. The coefficient decision unit 130 acquires from the driving history data, the average confidence level associated with the previous date and time. The average confidence level to be acquired is the previous average confidence level.

The change amount of average confidence level is a difference between the previous average confidence level and the current average confidence level. Specifically, the coefficient decision unit 130 calculates the change amount of average confidence level by subtracting the previous average confidence level from the current average confidence level.

Then, the coefficient decision unit 130 decides the current inspection coefficient based on the calculated change amount of average confidence level and the previous inspection coefficient.

The previous inspection coefficient is acquired as follows, for example. The driving history data in the storage device 220 indicates the inspection coefficient together with the driving location, associated with each date and time. The previous date and time is as described in step S130 of Embodiment 1. The coefficient decision unit 130 acquires from the driving history data, the inspection coefficient associated with the previous date and time. The inspection coefficient to be acquired is the previous inspection coefficient.

The current inspection coefficient is decided by any method based on the change amount of average confidence level and the previous inspection coefficient.

When the current average confidence level is greater than the previous average confidence level, and the change amount of average confidence level is a positive value, the current inspection coefficient is greater than the previous inspection coefficient.

When the current average confidence level is less than the previous average confidence level, and the change amount of average confidence level is a negative value, the current inspection coefficient is less than the previous inspection coefficient.

A difference (magnitude of a change in inspection coefficients) between the previous inspection coefficient and the current inspection coefficient increases as the change amount of average confidence level increases.

In step S240, the inspection value calculation unit 140 calculates the current inspection value using the current inspection coefficient and the current region confidence level.

Step S240 is the same as step S140 of Embodiment 1.

In step S250, the anomaly detection unit 150 determines whether or not an anomaly has occurred in the inspection target based on the current inspection value.

Step S250 is the same as step S150 of Embodiment 1.

### Key Features of Embodiment 2

Key features of Embodiment 2 will be described based on FIG. 6.

In time series of images at the same point, when the confidence levels of objects in the images improve overall, it is assumed that confidence (visibility or the like) of a later image is higher than that of a former image.

Therefore, the anomaly detection apparatus 100 modifies the coefficient K according to a change amount obtained in the former and later in the time series for average values of inference confidence levels (region confidence levels) of surrounding objects.
(1) When the inference average confidence level for detection results of the objects detected in the image is relatively low, the coefficient K becomes small.
(2) The inference average confidence levels for detection results of the objects detected in the image is relatively high. In this case, the coefficient K becomes large.

### Effects of Embodiment 2

In Embodiment 2, the coefficient K is modified according to a change amount obtained in the former and later in the time series for average values of inference confidence levels (region confidence levels) of all objects (surrounding objects) detected in images. Then, Embodiment 2 performs determination using scores (inspection values) based on this coefficient.

As a result, Embodiment 2 can reduce false detection of a defect, and detect an anomaly in the inspection target.

### Embodiment 3

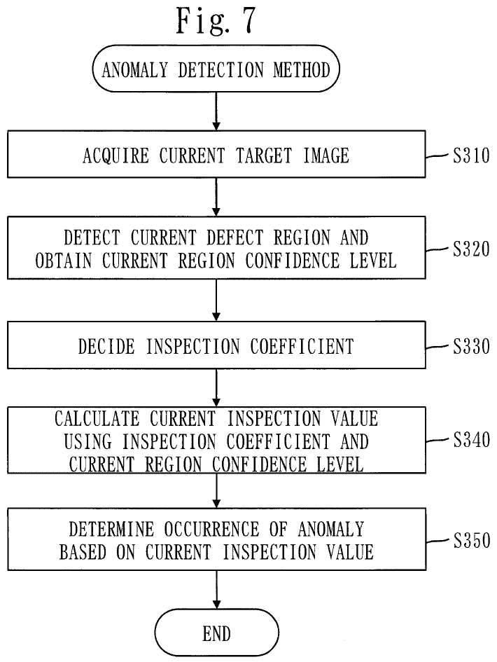

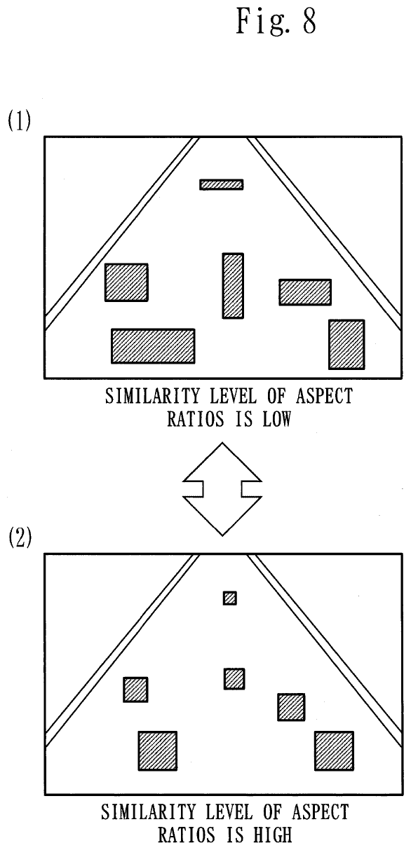

For an embodiment in which the inspection coefficient is decided based on an aspect ratio of the defect region, points that differ from Embodiment 1 will be mainly described based on FIGS. 7 and 8.

### Description of Configuration

A configuration of the anomaly detection apparatus 100 is the same as that in Embodiment 1.

### Description of Operation

The anomaly detection method will be described based on FIG. 7.

Steps S310 to S350 are equivalent to steps S110 to S150 in Embodiment 1.

In step S310, the image acquisition unit 110 acquires the current target image.

Step S310 is the same as step S110 in Embodiment 1.

In step S320, the object detection unit 120 detects the current defect region by executing object detection on the current target image.

Further, the object detection unit 120 obtains the region confidence level for the current defect region.

Specifically, the object detection unit 120 detects one or more current defect regions, and obtains one or more current region confidence levels corresponding to the one or more current defect regions.

The method of object detection is the same as the method in Embodiment 1.

The method of obtaining the region confidence level is the same as the method in Embodiment 1.

In step S330, the coefficient decision unit 130 decides the inspection coefficient.

The inspection coefficient is decided as follows.

First, the coefficient decision unit 130 calculates the aspect ratio of each of the one or more current defect regions, and obtains one or more aspect ratios corresponding to the one or more current defect regions.

Next, the coefficient decision unit 130 calculates a similarity level of the obtained one or more aspect ratios. The similarity level to be calculated is referred to as an aspect ratio similarity level.

Then, the coefficient decision unit 130 decides the inspection coefficient based on the calculated aspect ratio similarity level. The inspection coefficient is decided in any way based on the aspect ratio similarity level.

The inspection coefficient is inversely proportional to the aspect ratio similarity level. That is, the higher the aspect ratio similarity level, the smaller the inspection coefficient.

In step S340, the inspection value calculation unit 140 calculates the current inspection value using the inspection coefficient and the current region confidence level.

Step S340 is the same as step S140 in Embodiment 1.

In step S350, the anomaly detection unit 150 determines whether or not an anomaly has occurred in the inspection target based on the current inspection value.

Step S350 is the same as step S150 in Embodiment 1.

### Key Features of Embodiment 3

Key features of Embodiment 3 will be described based on FIG. 8.

When the similarity level of aspect ratios is high, there is a high possibility that there are many objects of the same type (fallen leaves, for example). Therefore, it is necessary to increase the coefficient K.

Therefore, when the similarity level of aspect ratios of surrounding objects is high (when a variance of the aspect ratios is small, for example), the anomaly detection apparatus 100 reduces the coefficient K.
(1) Regarding a detection result for objects detected in an image, when the aspect ratio of the bounding box for each object is not similar to those of the others (when the similarity level is low), the coefficient K increases.
(2) Regarding a detection result for objects detected in an image, when the aspect ratio of the bounding box for each object is similar to those of the others (when the similarity level is high), the coefficient K decreases.

### Effects of Embodiment 3

When the similarity level of aspect ratios of surrounding objects is high (when the number of surrounding objects whose similarity level of aspect ratios is high, for example), the coefficient K reduces in Embodiment 3. Then, Embodiment 3 performs determination using scores (inspection values) based on this coefficient.

As a result, Embodiment 3 can reduce false detection of a defect, and detect an anomaly in the inspection target.

### Supplement to Embodiments

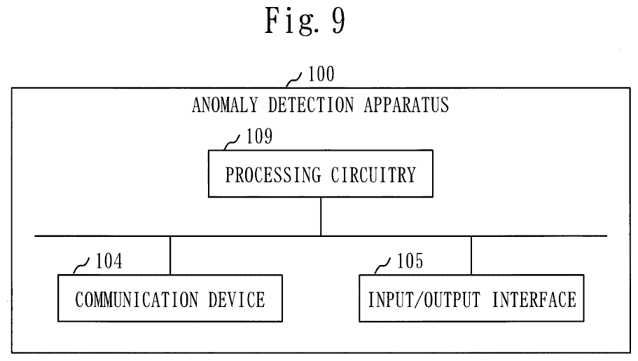

A hardware configuration of the anomaly detection apparatus 100 will be described based on FIG. 9.

The anomaly detection apparatus 100 includes processing circuitry 109.

The processing circuitry 109 is a piece of hardware that implements the image acquisition unit 110, the object detection unit 120, the coefficient decision unit 130, the inspection value calculation unit 140, and the anomaly detection unit 150.

The processing circuitry 109 may be dedicated hardware, or may be the processor 101 that executes programs stored in the memory 102.

When the processing circuitry 109 is the dedicated hardware, the processing circuitry 109 is, for example, a single circuit, a compound circuit, a programmed processor, a parallel programmed processor, an ASIC, an FPGA, or a combination of these.

ASIC is an abbreviation for Application Specific Integrated Circuit.

FPGA is an abbreviation for Field Programmable Gate Array.

In the processing circuitry 109, some functions may be implemented by the dedicated hardware, while the remaining functions may be implemented by software or firmware.

In such a manner, a function of the anomaly detection apparatus 100 can be implemented by hardware, software, firmware, or a combination of these.

Each embodiment is an example of a preferable embodiment and is not intended to limit the technical scope of the present disclosure. Each embodiment may be implemented partially, or may be implemented in combination with another embodiment. The procedures described using the flowcharts or the like may be suitably modified.

“Unit” of each element of the anomaly detection apparatus 100 may be interpreted as “process”, “step”, “circuit”, or “circuitry”.

### REFERENCE SIGNS LIST

100: anomaly detection apparatus; 101: processor; 102: memory; 103: auxiliary storage device; 104: communication device; 105: input/output interface; 109: processing circuitry; 110: image acquisition unit; 120: object detection unit; 130: coefficient decision unit; 140: inspection value calculation unit; 150: anomaly detection unit; 190: storage unit; 200: anomaly detection system; 201: mobile object; 210: imaging device; 220: storage device; 230: positioning device.

1. An anomaly detection apparatus comprising:
processing circuitry:
to detect a region in which a defect of an inspection target is inferred to appear, as a current defect region, by executing object detection on a current target image acquired by imagining the inspection target, and to obtain accuracy of inference for the current defect region, as a current region confidence level;
to calculate a current inspection value using an inspection coefficient used for calculating an inspection value and the current region confidence level; and
to determine whether or not an anomaly has occurred in the inspection target based on the current inspection value.

2. The anomaly detection apparatus according to claim 1, wherein
the processing circuitry calculates a change amount of region confidence level using a previous region confidence level and the current region confidence level, and calculates the current inspection value by adding to a previous inspection value, a value obtained by calculating by multiplying the calculated change amount of region confidence level by the inspection coefficient.

3. The anomaly detection apparatus according to claim 1, wherein
the processing circuitry decides the inspection coefficient based on a length of an uninspected period that is equivalent to a period from a previous imaging time to a current imaging time.

4. The anomaly detection apparatus according to claim 1, wherein
the processing circuitry decides a current inspection coefficient as the inspection coefficient,
the processing circuitry detects one or more current defect regions, and obtains one or more current region confidence levels corresponding to the one or more current defect regions, and
the processing circuitry calculates an average of the one or more current region confidence levels as a current average confidence level, calculates a change amount of average confidence level using the previous average confidence level and the current average confidence level, and decides the current inspection coefficient based on the calculated change amount of average confidence level and the previous inspection coefficient.

5. The anomaly detection apparatus according to claim 1, wherein
the processing circuitry decides the inspection coefficient,
the processing circuitry detects one or more current defect regions, and obtains one or more current region confidence levels corresponding to the one or more current defect regions, and
the processing circuitry calculates an aspect ratio for each of the one or more current defect regions to acquire one or more aspect ratios corresponding to the one or more current defect regions, calculates a similarity level of the acquired one or more aspect ratios, as an aspect ratio similarity level, and decides the inspection coefficient based on the calculated aspect ratio similarity level.

6. An anomaly detection method comprising:
detecting a region in which a defect of an inspection target is inferred to appear, as a current defect region, by executing object detection on a current target image acquired by imagining the inspection target, and obtaining accuracy of inference for the current defect region, as a current region confidence level;
calculating a current inspection value using an inspection coefficient used for calculating an inspection value and the current region confidence level; and
determining whether or not an anomaly has occurred in the inspection target based on the current inspection value.

7. The anomaly detection apparatus according to claim 2, wherein
the processing circuitry decides the inspection coefficient based on a length of an uninspected period that is equivalent to a period from a previous imaging time to a current imaging time.

8. The anomaly detection apparatus according to claim 2, wherein
the processing circuitry decides a current inspection coefficient as the inspection coefficient,
the processing circuitry detects one or more current defect regions, and obtains one or more current region confidence levels corresponding to the one or more current defect regions, and
the processing circuitry calculates an average of the one or more current region confidence levels as a current average confidence level, calculates a change amount of average confidence level using the previous average confidence level and the current average confidence level, and decides the current inspection coefficient based on the calculated change amount of average confidence level and the previous inspection coefficient.

9. The anomaly detection apparatus according to claim 2, wherein
the processing circuitry decides the inspection coefficient,
the processing circuitry detects one or more current defect regions, and obtains one or more current region confidence levels corresponding to the one or more current defect regions, and
the processing circuitry calculates an aspect ratio for each of the one or more current defect regions to acquire one or more aspect ratios corresponding to the one or more current defect regions, calculates a similarity level of the acquired one or more aspect ratios, as an aspect ratio similarity level, and decides the inspection coefficient based on the calculated aspect ratio similarity level.
